(19) United States
(12) Patent Application Publication
(10) Pub. No.: US 2007/0068396 A1
(43) Pub. Date: Mar. 29, 2007

(54) Cheese processing apparatus

(76) Inventor: Gregory Charles Mission, Tauranga (NZ)

Correspondence Address: YOUNG & THOMPSON, 745 SOUTH 23RD STREET, 2ND FLOOR, ARLINGTON, VA, 22202, US

(21) Appl. No.: 10/568,878

(22) PCT Filed: Aug. 20, 2004
(86) PCT No.: PCT/NZ04/00190

§ 371 Date: Nov. 7, 2006

(30) Foreign Application Priority Data
Aug. 21, 2003 (NZ) 527738

(51) Int. Cl. A01J 11/00

(52) U.S. Cl. 99/452

(57) ABSTRACT

Method and apparatus for the substantially continuous processing of cheese. The apparatus processes cheese milk (coagulum) through to particulate cheese. The apparatus includes a de-watering or cheddering tower having a column with an inlet in which a pillar of cheese can fuse. Drainage manifolds allow the whey to discharge. The column joins with a detritising cutting element provided at the lower end thereof. The cutting element removes cheese from the pillar as it makes contact therewith. Simultaneously and consequently the cutting element forms a quantity of particulate cheese which is deposited into a conveyor for transport downstream. Secondary detritising element may be included and preferably both detritising elements are mounted in a hopper with the conveyor at the lower end thereof. The inlet include a hopper 1 to enable particulate cheese to be charged into the column.

### TECHNICAL FIELD

This invention relates to cheese processing apparatus and in particular to an apparatus for the substantially continuous processing of cheese milk to and/or through a required cheese in a fused form. More particularly, the invention relates to a tower type processing apparatus for handling the dewatering and other manufacturing stages inherent in cheese producing.

There are many variations of the basic stages in cheese processing ranging from the initial draining or dewatering of a cheese and whey mixture, cheddaring to a hard or solid state through to salting, mellowing and block forming including forming larger blocks from several smaller blocks smaller blocks Herein we use the following terms to cover the various forms and stages involved in processing cheese milk to cheese. For the reasons outlined above these definitions should not be considered restrictive.

Cutting: the process of cutting cheese coagulum into curd.

Whey: residual liquid after cheese milk has been solidified either to a coagulum or the coagulum syneresised.

Cheese milk: milk that is suitable for the processing into cheese and which may or may not contain additives to facilitate one or more of the stages in that process.

Cheese: the fused state of the processing of cheese milk, either at a stage in processing or as a final product.

Coagulum: the state of cheese following processing of cheese milk either wholly or partly to enable partial draining or drawing off of whey.

Whey: residual liquid after cheese milk has been solidified either to a coagulum or the coagulum syneresised.

Curd: cheese coagulum in granular or other particulate form.

De-watering: the drainage or drawing of whey and/or other liquid during the process.

Detritusing: the crumbling, chopping or similar cutting up of cheese into a particulate or curd form.

### BACKGROUND ART

It is well known to form pillars of fused cheese by utilising drainage towers for the purposes of residence time and dewatering of cheese milk and whey mixture therein. These are often referred to as “cheddering” towers. Typically the towers are of an elongate upright form having a chamber in which dewatering takes place and a pillar of cheese forms. The chamber is typically in the form of an elongate column and is perforated for at least some of its length. For various reasons there are limitations to the capacity of the towers. In some cases this is overcome by providing a plurality of towers which may have a common input. Traditionally blocks are severed from the cheese pillar(s) and these are transported, such as by conveyers, to other apparatus, such as for detritusing (need for re-blocking, that is, forming larger blocks from several smaller blocks severed from the pillars) and/or salting for further processing. The resultant cheese blocks need to be conveyed to other apparatus for downstream processing. An alternative to the towers is the use of “flat belt conveyor” apparatus providing a “multi-level” drainage bed on which a wide substantially continuous “slab” of cheese milk and whey mixture dewaters or on which the cheese “slab” can be processed such as salted. Often detritusing apparatus is included between the belt layers. In either case a considerable “foot-print” is required to accommodate the both the originating dewatering apparatus and the detritusing apparatus and/or salting apparatus.

An object of this invention is to provide a compact apparatus and multi-functional cheese processing apparatus and thus reduce the “footprint” required therefor. A further object is to reduce the various separated and/or distinct apparatus required and the conveyor apparatus therebetween providing further running and maintenance costs. Overall an object of this invention is to provide a cheese processing apparatus that at least provides the public with a useful choice particularly as regards the capital cost in establishing a cheese processing plant

### DISCLOSURE OF THE INVENTION

According to a first aspect of this invention there is provided a cheese processing apparatus broadly comprising an elongate upright drainage column including inlet means adapted to charge the column with either cheese coagulum or detritused cheese to form a pillar of cheese therein and incorporating as a lower end outlet thereof means for detritusing the leading edge of the pillar of cheese as it descends from the column to form a quantity of particulate cheese and depositing such particulate cheese as it is formed onto transporting means for feeding to downstream processing means.

According to a second aspect of this invention there is provided a cheese processing apparatus as described in the preceding paragraph wherein an effective seal is formed at the transition of the pillar of fused cheese to the detritusing means to substantially prevent air entering the pillar of fused cheese via the detritusing means and wherein the detritusing means deposits the particulate cheese into a sealed hopper and the transport means comprises an auger disposed in an outlet from the hopper.

According to a third aspect of this invention there is provided a cheese processing apparatus as described in either of the two immediately preceding paragraphs salting means are incorporated into the inlet of the tower to enable salted curd to be charged thereinto.

According to a further aspect of this invention there is provided a method of processing cheese milk into cheese comprising the substantially continuous steps of charging the column of an apparatus as described in any one of the three immediately preceding paragraphs with a quantity of coagulum, allowing sufficient residency time therein for the coagulum to fuse to form a pillar of cheese, allowing the pillar of cheese to descend the column to contact the detritising means and thereby removing cheese form the pillar and simultaneously forming a quantity of particulate cheese and depositing the quantity of particulate cheese into the transporting means.

According to a yet a further aspect of this invention there is provided a method of processing cheese milk into cheese utilising an apparatus as defined in any one of the first three aspects of this invention to include the step of charging a quantity of particulate cheese into the column then allowing sufficient residency time therein for the particulate cheese to fuse to form a pillar of cheese, allowing the pillar of cheese to descend the column to contact the detritising means and thereby removing cheese form the pillar and simultaneously forming a further quantity of particulate cheese and depositing that quantity of particulate cheese into the transporting means.

### BRIEF DESCRIPTION OF DRAWINGS

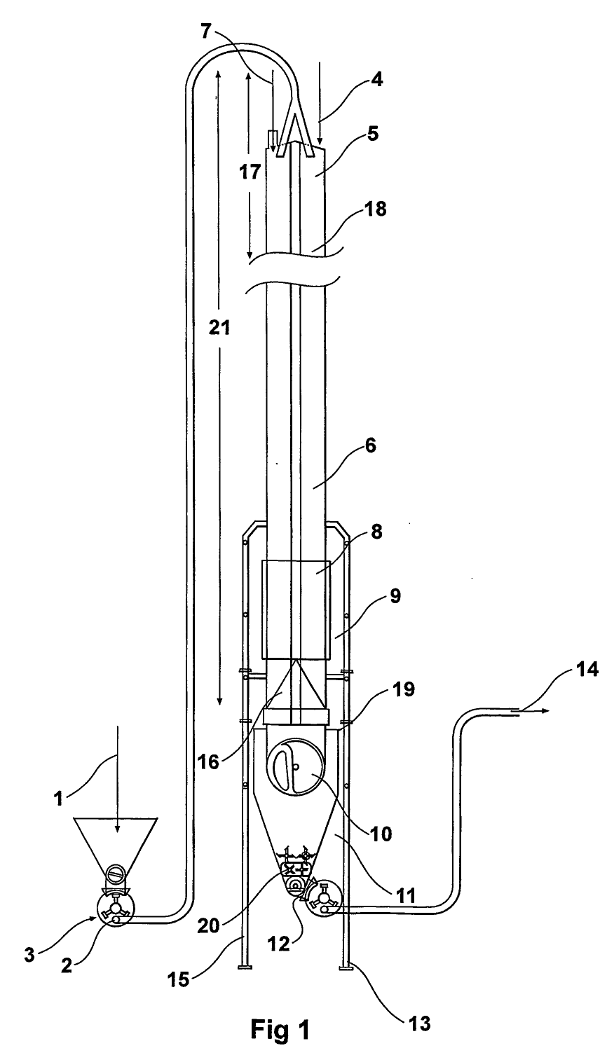

In further describing the invention reference is made to the accompanying drawing (FIG. 1) being a schematic partly cross-sectional side elevation of a preferred embodiment.

### BEST MODES OF CARRYING OUT THE INVENTION

A drainage tower 5 includes a support frame 15 and preferably has an input 4 at an upper end thereof. Typically when you used as a cheddering stage a cheese milk coagulum is supplied direct to inlet 4. As known with dewatering or cheddering towers the tower 5 is preferably cylindrical in cross-section and has an annular cheese pillar forming chamber 18 with both internal and external drainage manifolds 8. Preferably the internal drainage manifold 8 is connected to the outer manifold 8 at their lower ends by a radially disposed conduit(s) 19. Preferably the conduit 19 is “knife-edged” on its upper side to reduce hindrance to the descending cheese pillar.

Where the tower 5 is utilised for further downstream processing detritused cheese may be introduced to the inlet 4 such as via a hopper 1. Similarly and if appropriate simultaneously “salting” may be introduced via hopper 1. It follows the feed to the inlet 4 may include a blower or pump 3 preferably operating through an airlock valve 2 or other auxiliary equipment necessary for charging the tower 5 with the particular form of cheese concerned. While only one apparatus is depicted it is to be understood that a plant may include at least two apparatus coupled “in-line”. More particularly referring to the drawing, the first apparatus may not include a hopper 1 fed input, instead cheese coagulum being fed direct to inlet 1. The output 14 of the first apparatus can be transported to the input 1 of the second apparatus which may include the hopper 1.

Chamber 18 is vented at 7 and preferably includes a substantial upper section 17. It is envisaged that section 17 will, under normal working conditions not become charged. This design feature thereby provides a corresponding buffer zone between the inputs and output capacities of the tower 5. It is envisaged that this feature coupled with the detritusing means described in more detail below for working the fused cheese at the output of the tower 5 will enable the tower 5 to have a substantially larger volumetric capacity than known towers.

At a lower end the chamber 18 preferably includes a cylindrical to rectangular transition section 16 leading to detritusing means. The detritusing means preferably includes a rotary cutting device 10 to substantially continuously detritus the lower end of a pillar of fused cheese formed in the chamber 18 as it descends therefrom onto the cutting device 10. The cutting device 10 thus simultaneously forms a quantity of particulate cheese and deposits the particulate cheese as it is formed. Preferably the structure of the transition section 16 and/or the detritusing cutting device 10 provides for the sealing off of a pillar of fused cheese at this stage to substantially prevent air venting into the pillar at this juncture.

Preferably the cutting device 10 deposits the detritus cheese into a hopper 11 disposed directly beneath the chamber 18 to thus be gravity fed from the detritusing cutting device 10. The hopper 11 is preferably formed as part of the lower end of tower 5 structure and is preferably enclosed. The detritusing means may include a secondary crumbling means 20 to further cut-up or crumble the fused cheese as required. At an outlet of the hopper 11 transport means such as an auger 12 is preferably provided to pump the detritus cheese through an airlock 13 controlled enclosed conduit to downstream processing means as indicated by arrow 14.

As briefly mentioned at the outset the apparatus can be utilised in a complete processing method, such as processing cheese coagulum into cheese. This method comprises the substantially continuous steps of charging the column 18 with a quantity of coagulum. The coagulum is allowed sufficient residency time therein for the lower section of the coagulum to fuse to form a pillar of cheese. As the pillar forms it is allowed to descend the column to contact the detritising cutting means 10. The detritising cutting means 10 is operated to remove a quantity of cheese form the pillar and simultaneously form a quantity of particulate cheese which is deposited into the transporting means 12.

Additionally the apparatus can be utilised to carry out an intermediate or stand alone step of cheese processing. Utilised in this method a quantity of particulate cheese is charged into the column 18. It will be appreciated by those skilled in the field that such particulate cheese will have a content of curd. Further, it may be that some “watering” of the particulate cheese is undertaken at this stage as part of the “downstream” processing. More particularly “salting” can be undertaken at this stage. The particulate cheese is then allowed sufficient residency time therein to fuse to form a “second stage” pillar of cheese. As before this pillar of cheese is allowed to descend the column to contact the detritising means to form, as described above, a further quantity of particulate cheese.

1. A cheese processing apparatus comprising an elongate upright drainage column including inlet means adapted to charge the column with either cheese coagulum or detritused cheese to form a pillar of cheese therein and incorporating as a lower end outlet thereof means for detritusing the leading edge of the pillar of cheese as it descends from the column to remove a quantity of cheese and simultaneously form therefrom a quantity of particulate cheese and deposit such particulate cheese onto transporting means for feeding the quantity of particulate cheese to downstream processing means.

2. A cheese processing apparatus as claimed in claim 1 wherein an effective seal is formed at the transition of the pillar of fused cheese to the detritusing means to substantially prevent air entering the pillar of fused cheese via the detritusing means and wherein the detritusing. neans deposits the particulate cheese into a sealed hopper and the transport means comprises an auger disposed in an outlet from the hopper.

3. A cheese processing apparatus as claimed in claim 1 wherein salting means are incorporated into the inlet means of the tower to enable salted particulate cheese to be charged thereinto.

4. A cheese processing apparatus as claimed in claim 1 wherein a secondary detritusing means is provided to receive and further particulate the quantity of particulate cheese prior to being deposited into the transport means.

5. A method of processing cheese milk into cheese comprising the substantially continuous steps of charging the column of an apparatus as claimed in claim 1 with a quantity of coagulum, allowing sufficient residency time therein for the coagulum to fise to form a pillar of cheese, allowing the pillar of cheese to descend the column to contact the detritising means and thereby removing cheese form the pillar and simultaneously forming a quantity of particulate cheese and depositing the quantity of particulate cheese into the transporting means.

6. A method of processing cheese milk into cheese utilising an apparatus as claimed in claim 1 inclusive to include the step of charging a quantity of particulate cheese into the column then allowing sufficient residency time therein for the particulate cheese to fuse to form a pillar of cheese, allowing the pillar of cheese to descend the column to contact the detritising means and thereby removing cheese form the pillar and simultaneously forming a further quantity of particulate cheese and depositing that quantity of particulate cheese into the transporting means.

7. A method of processing cheese milk into cheese utilising at least two of the apparatus as claimed in claim 1 inclusive wherein the transporting means of a first of the apparatus is connected to an input of a second of the apparatus.

8. A method of processing cheese as claimed in claim 7 wherein the second apparatus includes salting means in the inlet thereto.

9. (canceled)

10. (canceled)
